(19) United States
(12) Patent Application Publication
(10) Pub. No.: US 2002/0140818 A1
(43) Pub. Date: Oct. 3, 2002

(54) System and method for generating raster video test patterns

(75) Inventor: David Rowe, Campbell Hall, NY (US)

Correspondence Address: Alan M. Weisberg, Christopher & Weisberg, P.A., Suite 2040, 200 East Las Olas Boulevard, Fort Lauderdale, FL, 33301, US

(73) Assignee: Pelco

(21) Appl. No.: 10/115,113

(22) Filed: Apr. 2, 2002

Related U.S. Application Data
(60) Provisional application No. 60/280,875, filed on Apr. 2, 2001.

(51) Int. Cl. H04N 17/00; H04N 7/18

(52) U.S. Cl. 348/181; 348/143

(57) ABSTRACT

A device and method are provided device for generating a test pattern on a video display unit having a first quantity of raster scan lines, in which there is a logic processor and a memory. The memory is electrically connected to the logic processor. The memory stores test pattern data corresponding to a second quantity of raster scan lines in which the second quantity of raster scan lines is less than the first quantity of raster scan lines. The memory provides a digital video signal output.

### CROSS-REFERENCE TO RELATED APPLICATION

This application is related to and claims priority to U.S. Provisional Application Ser. No. 60/280,875, filed Apr. 02, 2001, entitled VIDEO SYSTEM AND METHOD, the entirety of which is incorporated herein by reference.

### STATEMENT REGARDING FEDERALLY SPONSORED RESEARCH OR DEVELOPMENT

n/a

### FIELD OF THE INVENTION

The present invention relates to video systems, and, in particular, to a method and system for generating raster video test patterns in video surveillance systems.

### BACKGROUND OF THE INVENTION

Advanced video systems require built-in patterns and raster video generators to provide a background for menus and non-operating video inputs. These patterns may also be used to test a video system for operationality or for compatibility with other systems, such as to calibrate the color settings across a network of video display monitors in a closed circuit system. These signals are difficult to generate and often too expensive to include in video equipment.

Known raster video generators use a ROM or flash ROM to store individual lines of video, for read-out by outputting a word that represents a few pixels of video into a shift register, and then shifting out that data pixel by pixel while the ROM address increments to provide the next group of pixels until the line is completed. The ROM address then increments to the next line and the process continues. Often, the next line may be the same as the previous one, but this repeated data still takes up valuable ROM space, making ROM requirements and device requirements larger and more expensive. For a video display of millions of pixels and potentially millions of bits per pixel, this amounts to a huge memory requirement.

It is desirable therefore, to provide a device and method for storing test patterns in a video system which minimizes the memory needed to store such patterns.

### SUMMARY OF THE INVENTION

The present invention advantageously provides a method and system for storing and generating test patterns in memory for use in video displays.

According to an aspect, the present invention provides a device for generating a test pattern on a video display unit having a first quantity of raster scan lines. The device includes a logic processor and a memory electrically connected to the logic processor. The memory stores a test pattern data corresponding to a second quantity of raster scan lines. The second quantity of raster scan lines is less than the first quantity of raster scan lines. The memory provides a digital video signal output.

According to another aspect, the present invention provides a video system, which includes a camera, a keyboard controller, and a video display unit being operatively connected to each other through a switch. The video display unit includes a first quantity of raster scan lines. The switch includes a test pattern generator, having a logic processor, and a memory electrically connected to the logic processor. The memory stores a test pattern data corresponding to a second quantity of raster scan lines. The second quantity of raster scan lines is less than the first quantity of raster scan lines. The memory provides a digital video signal output.

In yet another aspect, the present invention provides a method of generating a test pattern on a video display. A counting signal corresponding to a quantity of raster scan lines is produced. A unique raster scan line data is transmitted to the video display in response to a first portion of the counting signal. The repeatable raster scan line data is repeatedly transmitted to the video display a predetermined quantity of times in response to a second portion of the counting signal.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary video surveillance system arranged in accordance with the principles of the present invention;

FIG. 2a illustrates a raster display with a single color test screen;

FIG. 2b illustrates a raster display with a set of vertical color bars as a test screen;

FIG. 3 illustrates a raster display divided into field lines for a NTSC format video signal;

FIG. 4 illustrates a block diagram of the components used to store and generate the test patterns shown in FIGS. 2a and 2b; and

FIG. 5 is a diagram of the logic performed by one embodiment of the FPGA shown in FIG. 4.

### DETAILED DESCRIPTION OF THE INVENTION

As used herein, the term “raster” shall mean the rectangular area of a display screen or monitor actually being used to display images. The raster is slightly smaller than the physical dimensions of the display screen. Also, the raster may vary for different resolutions of video images. The raster is in turn divided in a set of horizontal scan lines vertically stacked adjacent to one another. Each scan line bears a whole number index, j. In interlaced scan display arrangements, the raster lines are further divided into a pair of interlaced “fields”, with those lines where j=odd representing the “odd” field, and those lines where j=even representing the “even” field. Each scan line in a raster represents a number of samples of video information, arranged horizontally, such as pixels, with each pixel being represented in the video signal with a range of brightness, color, and spectral intensity data.

In accordance with NTSC (National Television Standards Committee) video standards, an NTSC raster consists of 525 total lines composed of two interlaced fields of 262 and one half lines each. Each field represents a single half-frame of video, and is displayed at 60 Hz. The present invention is equally suited to work with other television and video standards, such as PAL (Phase Alternating Line), which uses half-frames of 312 or 313 lines for a total of 625 lines, at 50 Hz.

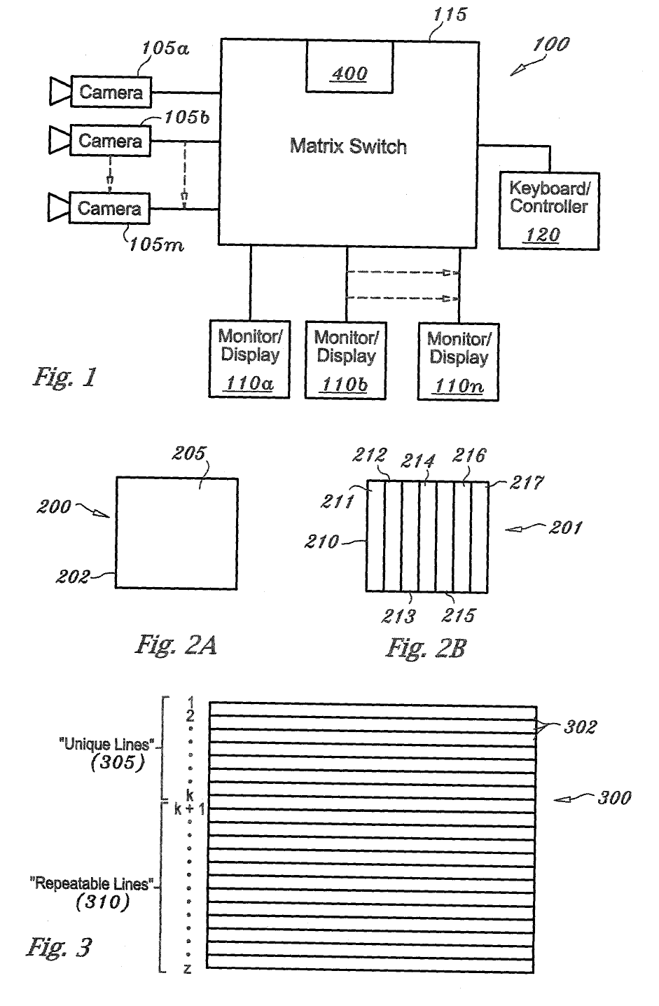

Referring now to the drawing figures, in which like reference designators refer to like elements, there is shown in FIG. 1 a block diagram of a video surveillance system, such as a closed circuit television (CCTV) system, for use in monitoring multiple scenes from multiple locations, constructed in accordance with the principles of the present invention and designated generally as 100. System 100 includes up to “m” video cameras 105a, 105b, through 105m, along with up to “n” video monitors or displays 110a, 110b, through 110n, (where “m” and “n” are whole numbers) coupled to a video switch, having at least one keyboard controller 120 connected thereto.

The cameras 105 maybe any of a variety of video or still cameras, acquiring a picture using a lens, iris, zoom and focus controls, integrated optics package, or other image acquisition device. The cameras 105 may be included inside of a housing such a semi-hemispherical dome, suitable for affixation onto a surface. The housing may also include a set of orientational controls, such as pan and tilt motors and actuators for moving and orienting the direction of the image acquisition device. An example of such a camera 105 and housing is the SPECTRA series of video surveillance units manufactured by Pelco.

Each camera 105 is connected to the video switch 115, such a multi-input and output “matrix” switch. The switch 115 contains a variety of components, including a computer and control circuit electronics for controlling the operation of each camera 105, through commands and codes received by the keyboard controller 120. Both the cameras 105 and keyboard controller 120 may be disposed at remote locations from the switch 115. The switch 115 is further connected to a number “n” of monitor displays 110. The “matrix” therefore, contains m×n channels for m camera inputs and n monitor outputs. One example of such a matrix switch is the CM 6800 switch manufactured by Pelco, which provides m=48 and n=8. The keyboard controller 120 is further used to control the appearance of the video signals on the monitors 110, such the overall brightness, contrast, and the nature of the display of character text onto the images acquired by the cameras 105, as more fully described below.

Switch 115 also includes a test pattern generator 400, which is discussed in greater detail below. First however, a general description of the test patterns themselves is provided, as well as the layout of a typical video raster and display as constructed in accordance with the principles of the present invention.

FIGS. 2a and 2b illustrate two test patterns, a single color screen 200 such as a blue screen and a set of color bars 201, respectively, that may be stored in the system 100 described in FIG. 1.

As shown in FIG. 2a, the display screen 200 is generally displayed on a raster 202 with a screen 205 filled with scan lines which are all of one color and intensity, such as blue. This test pattern is often useful for testing the basic functionality of a video system, such as for example, to test if the signals and communication between the switch 115 and monitors 110 in FIG. 1 are connected and operating properly. The test pattern generator 400 is triggered by a command from the keyboard controller 120 to produce the foregoing test patterns 200 and 201, whose signal is thereafter routed to the various monitors 110. A user may thus check the operational functionality of the video display systems. Alternatively, the blue test pattern 200 may be used as a background for displaying text or other information on any of the monitors 110, as is often used video surveillance systems. Still another use of such a test pattern is in the event of a system failure, anomaly, error, or alarm event, thereby allowing a user to quickly be alerted on the state of the system 100. Of course, it is readily understood that blue is not the only possible color to be used in test pattern 200, as any monochromatic pattern may be used with a variety of colors, depending on the particular color display characteristics used in system 100.

FIG. 2b illustrates a particular test pattern 201 used to check the color settings in each of monitors 110. Within raster 210, test pattern 201 includes a set of seven vertical color bars 211-217, each having a different color. The colors are calibrated to particular standard of appearance, given a predetermined setting for each of the monitors 110. Thus, even if monitors 110 are misadjusted in contrast, color or other visual parameter, a user may always be able to calibrate the color setting by simply viewing test pattern 201.

It is readily understood that any other variety of test patterns may be used for the afore-mentioned purposes, and the present invention is not limited to the foregoing examples. However, the uniqueness of each of test patterns 200 and 201 are that the video “information” in each pattern does not change in the vertical direction. That is, any horizontal slice of the pattern will result in an identical element.

FIG. 3 illustrates a simplified schematic of a video display raster 300 divided into a plurality of scan lines 302. Each scan line 302 is indexed by a counter j. The raster 300 is divided into two sets of lines, the “unique” lines 305 and the “repeatable lines” 310. A certain number of lines k are unique lines 305, which correspond to the vertical blanking area of the video signal which is generally not displayed and instead contains other data and information which may be used in generating and reading the video signal on a video display. The remainder of the total number of lines z take up the viewable or “repeatable” scan lines 310. Lines 310 are used to display the test patterns 200 and 201 discussed above. In a typical video arrangement, where a NTSC (National Television Standards Committee) video signal is used in system 100, k=24, and z=262 or 263. In a NTSC signal, each of the set of scan lines 302 only represents one half-frame or “field” of video, where the total number of lines displayed on a television screen is actually 525. The present invention is equally suited to work with other television and video standards, such as PAL (Phase Alternating Line), which uses half-frames of 312 or 313 lines for a total of 625 lines.

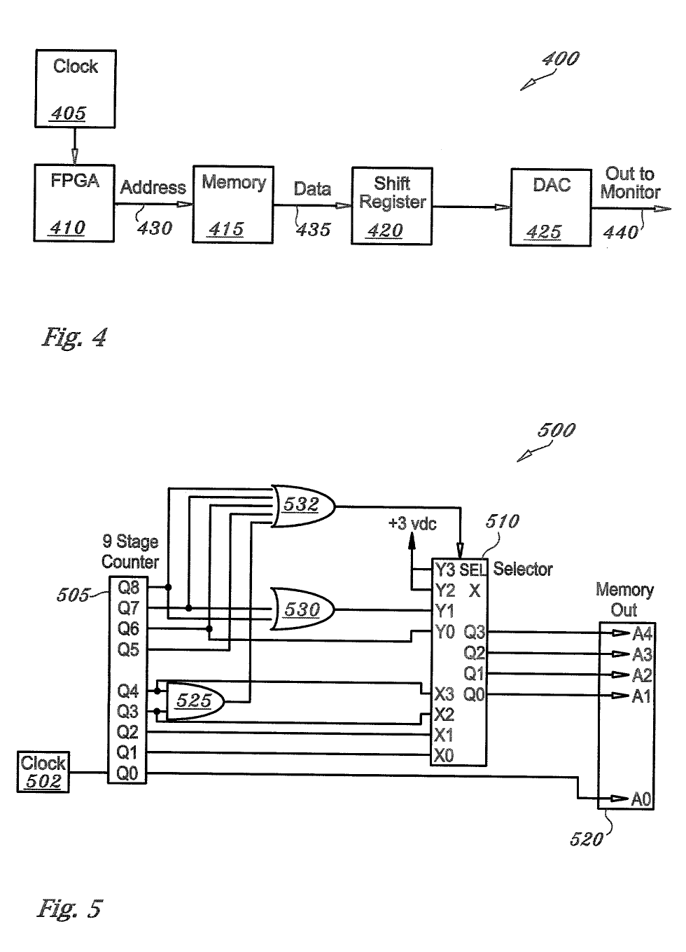

Turning now to FIG. 4, there is shown a block diagram of the test pattern generator 400, which is preferably included as part of switch 115 in system 100 of FIG. 1. Of course, the test pattern generator 400 can be a separate assembly from the switch 115 and be electrically coupled thereto. Test pattern generator 400 includes a clock 405, a logic processor 410 such as a field programmable gate array (FPGA), microcontroller or central processing unit, a read-only memory (ROM) 415 such as a flash memory, a shift register 420 and a digital to analog converter (DAC). The clock 405 controls and synchronizes the logic processor 410, which in turn sends address data and commands to the ROM through an address bus 430. The ROM sends test pattern data to the shift register 420 through a data bus 435. The shift register 420 receives data words from the ROM 415, and shifts out that data pixel by pixel to the DAC 425, for eventual conversion to analog. The resulting analog video signal is output to a display monitor connected to the switch 115.

ROM 415 is divided into several memory locations, each having a certain “vertical address”, an address defining the vertical position of each line (which can be represented by index j) on the raster display 300. The test patterns, such as test patterns 200 and 201 are “burned” into the ROM 415 upon its manufacture or programmed in the field. Generally, in known systems, for a test pattern, the lines of video 302 shown in FIG. 3 are output from the ROM 415 line by line, while the vertical address of the ROM 415 is incremented for each new line. As stated above, only when j>k, up to z lines (where z is the maximum number of lines on the display for one field) is data representing a viewed area of the raster displayed. For j<k, no video information is conveyed. However, in known systems, from j=k+1 to j=z, the ROM 415 vertical address is incremented by the logic processor 410 for each line, and video information is transferred through the shift register 420 and DAC 425 out to the monitor. Thus, for k<j<z, the ROM 415 is loaded with hundreds of lines of video data in prior art systems.

In test pattern generator 400 of the present invention, the logic processor 410 is programmed with a defined logic to increment the vertical address of the ROM 415 only up to and through j=k+1. For k+1<j<z, the logic processor 410 does not increment the vertical address of the ROM. Thus, for each new line of video, for k+1<j≦z, the same video data stored in ROM 415 for j=k+1 is repeatedly read out into the shift register 420. In this manner, the storage requirements for the ROM 415 are greatly reduced. Since each test pattern 200 and 201, as discussed above, contain lines which do not vary in the vertical dimension, the test patterns 200 and 201 may be stored in ROM 415, such that each line of data is identical to another, and the output of test pattern generator 400 is that shown in FIGS. 2a and 2b.

The logic processor 410 generally uses a set of binary counters (not shown), with the count output being used to send the addresses through the address bus 430 to the memory 415. The timing for a conventional device not arranged in accordance with the principles of the present invention would have a counter increase with each clock 405 cycle until the all the pixels of each line are displayed and the addresses for the next line are sent, and so on, until the entire frame is filled. The logic processor 410 of the present invention advantageously includes logic which “short-circuits” certain bits of the binary counter such that the address bits are only incremented up to a set threshold. In the embodiment of the invention discussed above, this maximum address corresponds to line j=25. For each count of the binary counter corresponding to addresses for lines beyond j=25, the addresses are short-circuited from the binary counter such that only the address for j=25 is sent by the logic processor 410 to memory 415. In this fashion, the viewing area of the raster continually repeats line j=25 throughout the frame of the display, and only one line of data is required to be stored in the ROM 415 to display such a pattern.

In another embodiment of the present invention, the logic processor 410 may be programmed with a second logic which short-circuits the binary counter such that for counts above j=24, only four distinct addresses are sent up through lines j=z for the two fields of an NTSC or PAL signal. In this embodiment therefore, the viewable area of the raster may show any combination of lines, each line being selected from one of four lines stored in the ROM 415, each line having its own address therein. The logic processor 410 is programmed to send a sequence of such four addresses to the ROM 415. The four lines may represent four different test pattern screens, four different colors, or 4 distinct repeatable lines.

FIG. 5 is illustrates a diagram of the logic elements such an embodiment of the logic processor 410 shown in FIG. 4. The logic circuit 500 includes a clock input 502, a nine stage counter 505, a chip 510, an AND gate 525, a first OR gate 530, a second OR gate 532, and a 5 stage memory address output 520. The nine stage input 505 corresponds to a binary counter (not shown) counting up to a count of 384, with “Q0” through “Q9” in input 505 representing the first and ninth bits, respectively, of the output of the binary counter. The maximum of 384 easily accommodates the 262 or 263 field lines in an NTSC signal, or the 312 or 313 lines in a PAL signal. In the memory address output 520, the five address bits “A0” through “A4” represent up to 32 addresses which may be routed to a memory. This encompasses the first 24 lines of video contained in a vertical blanking area as discussed above, but also allows for up to 8 repeatable lines of video through 8 extra available addresses to correspond to such repeatable lines.

As shown in FIG. 5, selector 510 has two sets of inputs “X0” through “X3” and “Y0” through “Y3”. Selector 510 also has a set of four outputs “Q0” through “Q3” as well as a selector switch “SEL X”. When SEL X receives a true or logic high input from OR gate 532, the chip outputs “Q0” through “Q3” equal the inputs “Y0” through “Y3”, respectively. When SEL X receives a false or logic low input from OR gate 532, the chip outputs “Q0” through “Q3” equal the inputs “X0” through “X3”, respectively.

As shown in FIG. 5, Q0 from counter 505 is routed to A0, Q1 from counter 505 is routed to X0; Q2 from counter 505 is routed to X1; Q3 from counter 505 is routed to X2; Q4 from counter 505 is routed to X3; Y0 is connected to Q6 from counter 505; Y1 is connected to the output of the two-input OR gate 530, which takes in Q7 and Q8; and both Y2 and Y3 are set to high. OR gate 532 is a five input OR gate, taking in 5 inputs: (i) the output of AND gate 525 having Q3 from counter 505 and Q4 as inputs thereto; and (ii) and Q5, Q6, Q7, and Q8, respectively.

The benefits of the present invention are that a smaller size ROM 415 may be used to store test patterns to be displayed in video systems, such as video surveillance systems. The overall cost, size, and complexity of such video systems are thereby reduced, resulting in advantageous use of components.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A device for generating a test pattern on a video display unit having a first quantity of raster scan lines, comprising:
a logic processor; and
a memory electrically connected to the logic processor, the memory storing a test pattern data corresponding to a second quantity of raster scan lines, the second quantity of raster scan lines being less than the first quantity of raster scan lines, the memory providing a digital video signal output.

2. The device according to claim 1, further comprising:
a binary counter coupled to the logic processor and the clock, the binary counter transmitting a counter data signal corresponding to the first quantity of raster scan lines,
wherein the memory comprises at least a quantity of memory addresses corresponding to the second quantity of raster scan lines, the logic processor receiving the counter data signal and transmitting an address data signal to the memory, the digital video signal output corresponding to the test pattern data.

3. The device according to claim 2, wherein the test pattern data includes a window blanking data and at least one repeatable raster scan line data, and the first quantity of raster scan lines comprises a quantity of unique raster scan lines and a quantity of repeatable raster scan lines.

4. The device according to claim 3, wherein the quantity of memory addresses comprises:
a quantity of unique raster scan line addresses corresponding to the quantity of unique raster scan lines and to the window blanking data; and
at least one repeatable raster scan line address corresponding to the at least one repeatable raster scan line data.

5. The device according to claim 4, wherein the address data signal includes a sequence of line addresses, the sequence of line addresses including the unique raster scan line addresses followed by at least one repeatable raster scan line address.

6. The device according to claim 5, wherein the at least one repeatable raster scan line address is repeated a quantity of times equal to the quantity of repeatable raster scan lines, and the digital video signal output comprises the at least one repeatable raster scan line data displayed on each of the quantity of repeatable raster scan lines, the quantity of repeatable raster scan lines corresponding to a viewable portion of a video display.

7. The device according to claim 3, wherein the at least one repeatable raster scan line data comprises a plurality of repeatable raster scan line data, each of the plurality of repeatable raster scan line data having a corresponding raster scan line address.

8. The device according to claim 7, wherein the first repeated quantity of the plurality of repeatable raster scan line addresses correspond to a respective one of a plurality of repeatable raster scan line addresses.

9. The device according to claim 1, further comprising a digital to analog converter electrically connected to the memory, the digital to analog converter receiving the digital video signal output and transmitting an analog video signal.

10. The device according to claim 9, wherein the analog video signal output comprises a television format selected from the group consisting of NTSC and PAL.

11. The device according to claim 1, wherein the logic processor is a field programmable gate array.

12. The device according to claim 1, wherein the memory is a flash memory.

13. A video system, comprising:
a camera;
a keyboard controller;
a video display unit having a first quantity of raster scan lines;
a switch, the camera, keyboard controller and video display unit being operatively connected to each other through the switch, the switch including a test pattern generator, the test pattern generator comprising:
logic processor; and
a memory electrically connected to the logic processor, the memory storing a test pattern data corresponding to a second quantity of raster scan lines, the second quantity of raster scan lines being less than the first quantity of raster scan lines, the memory providing a digital video signal output.

14. The system according to claim 13, further comprising:
a binary counter coupled to the logic processor and the clock, the binary counter transmitting a counter data signal corresponding to the first quantity of raster scan lines,
wherein the memory comprises at least a quantity of memory addresses corresponding to the second quantity of raster scan lines, the logic processor receiving the counter data signal and transmitting an address data signal to the memory, the digital video signal output corresponding to the test pattern data.

15. The system according to claim 14, wherein the test pattern data includes a window blanking data and at least one repeatable raster scan line data, and the first quantity of raster scan lines comprises a quantity of unique raster scan lines and a quantity of repeatable raster scan lines.

16. The system according to claim 15, wherein the quantity of memory addresses comprises:
a quantity of unique raster scan line addresses corresponding to the quantity of unique raster scan lines and to the window blanking data; and
at least one repeatable raster scan line address corresponding to the at least one repeatable raster scan line data.

17. The system according to claim 16, wherein the address data signal includes a sequence of line addresses, the sequence of line addresses including the unique raster scan line addresses followed by at least one repeatable raster scan line address.

18. The system according to claim 17, wherein the at least one repeatable raster scan line address is repeated a quantity of times equal to the quantity of repeatable raster scan lines, and the digital video signal output comprises the at least one repeatable raster scan line data displayed on each of the quantity of repeatable raster scan lines, the quantity of repeatable raster scan lines corresponding to a viewable portion of a video display.

19. The system according to claim 15, wherein the at least one repeatable raster scan line data comprises a plurality of repeatable raster scan line data, each of the plurality of repeatable raster scan line data having a corresponding raster scan line address.

20. The system according to claim 13, wherein the test pattern generator further includes, a digital to analog converter electrically connected to the memory, the digital to analog converter receiving the digital video signal output and transmitting an analog video signal.

21. The system according to claim 20, wherein the analog video signal output includes a television format selected from the group consisting of NTSC and PAL.

22. The system of claim 13, wherein the logic processor is a field programmable gate array.

23. The system of claim 13, wherein the memory is a flash memory.

24. A method of generating a test pattern on a video display the method comprising:
producing a counting signal corresponding to a quantity of raster scan lines;
transmitting unique raster scan line data to the video display in response to a first portion of the counting signal; and
repeatedly transmitting the repeatable raster scan line data to the video display a predetermined quantity of times in response to a second portion of the counting signal.

25. The method of claim 24, further comprising storing the test pattern data.

26. The method of claim 25, further comprising:
generating an address signal;
inputting the address signal to the memory;
transmitting the unique raster scan line data from the memory to the video display; and
repeatedly transmitting the repeatable raster scan line data from the memory to the video display a quantity of times equal to the second portion of the counting signal.

27. The method of claim 19, wherein the address signal is generated by a logic processor.
